(19) United States
(12) Patent Application Publication
(10) Pub. No.: US 2004/0120246 A1
(43) Pub. Date: Jun. 24, 2004

(54) Information storage medium and optical device using the same

(76) Inventors: Kang-Ho Park, Daejeon (KR); Ki-Bong Song, Daejeon (KR); Eun-Kyoung Kim, Daejeon (KR); Jun-Ho Kim, Jinjoo (KR); Sung-Q Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/698,870

(22) Filed: Oct. 31, 2003

(30) Foreign Application Priority Data
Dec. 23, 2002 (KR) 2002-82855

(51) Int. Cl. G11B 9/00

(52) U.S. Cl. 369/126

(57) ABSTRACT

The present invention relates to an information storage medium and an optical device for reproducing information recorded in the information storage medium. In the information storage medium, the initial phase of any cell in the information layer is a crystal phase or an amorphous phase, and either of the two phases is changed into the other phase by electronic heating. Since reflectivity to incident light is different in accordance with phase of the cell, information recorded on the medium may be reproduced by using the above property.

### CROSS REFERENCE TO RELATED APPLICATION

This application is based on Korea Patent Application No. 10-2002-0082855 filed on Dec. 23, 2002, in the Korean Intellectual Property Office, the content of which is incorporated herein by reference.

### BACKGROUND OF THE INVENTION

(a) Field of the Invention

The present invention relates to an information storage medium and an optical device using the same. More specifically, the present invention relates to a phase change information storage medium using an electrical circuit mechanism of a matrix type. Moreover, the present invention relates to an optical device for recording information on the phase change information storage medium and for reproducing information from the phase change information storage medium.

(b) Description of the Related Art

In an optical storage medium such as a compact disc or a digital video disc, a wavelength of an optical source used for recording information on the medium should be reduced or a numerical aperture of an objective lens should be increased so as to store more information on each unit area of the medium.

In the case of reducing the wavelength of an optical source, it is possible to use a blue laser diode, which is composed of gallium-nitride (GaN), as an optical source. In the case of increasing the numerical aperture of an objective lens, the numerical aperture can presently be increased by 0.85. However, high density recording at more than 50 Gb/in² is restricted due to the diffraction limit of an optical beam. To overcome such restrictions on recording density, a recording method has been proposed that uses a near-field that has a resolution exceeding the diffraction limit of an optical beam. In addition, a multi-level recording method, a multi-layer recording method, and a holography method also have been proposed..

The multi-level recording method is based on two dimensional integration of an optical disc, and the multi-layer recording method and the holography method are based on three dimensional recording. In the case of the holography method, most of the technological source concepts have been established, and studies are presently focused on an organic medium for discs. Moreover,, in the case of the multi-layer recording method, the limit of layers to be increased is approximately four, so it is difficult to improve integration of an optical disc. However, a problem exists in the prior multi-level recording method in that it is impossible to reduce a recording pattern within. wavelengths due to diffraction of a light beam when information is recorded in accordance with a light beam recording method.

In addition, a recording medium using a rewritable and nonvolatile memory has been known in the United States, with U.S. Pat. No. 5,296,716. The recording medium records information electrically by using a phase change phenomenon due to electrical resistive heat of a chalcogenide thin film, and it reproduces information by electrically reading an electrical resistive change. A phase change thin film and a memory cell having an electrical heating structure are integrated in the recording medium of the prior patent so that high speed recording and reproducing of the recording medium may be obtained and a recording density of more than approximately terabits per second may be realized. However, the recording medium according to the prior patent is restricted in its recording velocity and number of times it may be rewritten so that the recording medium using the above described memory has technical limits in the application for a RAM (Random Access Memory).

As another prior patent, a multi-level optical recording medium has been known in the United States, U.S. Pat. No. 6,148,428. In the case of a prior optical disc, information recording and reproduction is implemented by using a recording bit with digits 0 or 1, while the multi-level optical recording medium uses the gray scale in recording and reproducing information by adjusting a crystalline level so that recording density may be improved. Since information is reproduced in the above optical recording medium by eight levels or twelve levels, it may have two or four times the recording density as compared with a conventional CD or DVD having the same dimensions. In other words, the above optical recording medium having the same size as the conventional medium may obtain an increase in recording density by two to four times. In general, the above method is called a multi-level recording method. However, the increase in recording density has a limit to some extent in the above recording medium when the wavelength of the light beam used in the recording medium becomes shorter.

Meanwhile, a recording medium to increase recording density and capacity has been published in Technical Digest, ISOM/ODS 2002, on pages 150 to 152. The above recording medium uses an angle change of the medium with a micro mirror as a recording pattern. Since the angle change in the above recording medium is detected by an additionally provided photo detector combination, information-recording capacity may be increased by tens times as compared with a conventional recording medium. However, the above recording medium has a technical limit in the manufacturing process in that the micro mirror medium may only be manufactured in a read only memory (ROM) configuration by a lithography process.

### SUMMARY OF THE INVENTION

The present invention provides an information storage medium having cells of less than a spot size of a light beam, and an optical device for reproducing information recorded on the medium.

The information storage medium according to the present invention uses an electro optical driving method (EOD). In the information storage medium, there are characteristics such that information is recorded on each cell by using a phase change at each cell that is changed by resistive heating, and the recorded information is reproduced by detecting a reflectivity difference due to the phase change distribution of each cell.

An information storage medium according to aspects of the present invention comprises:

a substrate;

a plurality of lower electrode lines that are arranged on the substrate to be in parallel with one another and apart from one another at a constant interval;

a plurality of upper electrode lines that are arranged to cross the lower electrode lines while being arranged in parallel with one another and apart from one another at a constant interval; and,

an information layer having cells that are arranged in a matrix and located at each crossing region of the lower electrode lines and the upper electrode lines.

In the information storage medium, an initial phase of any cell in the information layer is a crystal phase or an amorphous phase, and either one of the two phase is changed into the other phase by electronic heating. Since reflectivity of the incident light is different in accordance with the phase of the cell, information recorded on the medium may be reproduced by using the above property.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates an information storage medium according to a first embodiment of the present invention and an optical device for recording information on the medium;

FIG. 2 illustrates a cross-sectional view of an information storage medium according to a second embodiment of the present invention;

FIG. 3 illustrates an electrode structure when the information storage medium of the present invention is fabricated as a disc;

FIG. 4a and FIG. 4b illustrate a reproduction principle of an optical device for reproducing the information on the storage medium of the present invention; and

FIG. 5a and FIG. 5b illustrate an optical device further comprising a diffraction grating.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

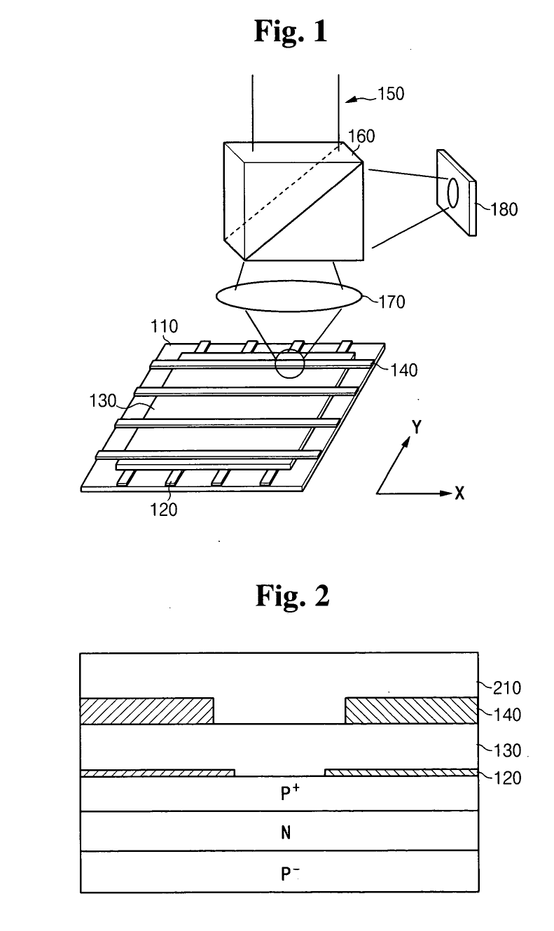

An information storage medium according to a first embodiment of the present invention and an optical device for recording information on the medium are illustrated in FIG. 1. A cross-sectional view of an information storage medium according to a second embodiment of the present invention is illustrated in FIG. 2. The information storage medium of the first embodiment is a passive type, and the information storage medium of the second embodiment is an active type.

With reference to FIG. 1, the information storage medium of the first embodiment will be described in the following.

As illustrated in FIG. 1, the information storage medium according to the first embodiment of the present invention comprises a substrate 110, a plurality of lower electrode lines 120 that are arranged in parallel with one another and are apart from one another at a constant interval, a plurality of upper electrode lines 140 that are arranged to cross the lower electrode lines while being arranged in parallel with one another and apart from one another at a constant interval, and an information recording layer 130 that is formed between the lower electrode lines 120 and the upper electrode lines 140. The information recording layer 130 is made of a phase-change medium including a chalcogenide material.

The above information storage medium may be fabricated as a card or a disc.

The lower electrode lines 120 and the upper electrode lines 140 may be formed of a metal material such as gold (Au), silver (Ag), copper (Cu), titanium (Ti), tungsten (W), aluminum (Al), titanium nitride (TiN), or aluminum nitride (AlN). At this time, it is preferable that the thickness of the electrode lines 120 and 140 are less than 50 nanometers, which is thick enough for the light to transmit the metal material. Moreover, the electrode lines 120 and 140 may be formed as transparent electrodes being made of indium-tin-oxide (ITO), which has high transmittance within the visible light spectrum.

Next, a procedure for recording information on the information storage medium in FIG. 1 will be described.

The information recording layer 130 is made of a phase-change thin film of which the phase may be changed by heat. In addition, the information recording layer 130 has cells that are arranged in a matrix and located at each crossing region of the lower electrode lines 120 and the upper electrode lines 140. The phase of each cell is controlled by a voltage difference between the corresponding,lower electrode line 120 and upper electrode line 140 located at each cell. The initial phase :of the information recording layer 130 is a crystal phase or an amorphous phase. Either of the two phases may be transformed into the other one by electrical heating. The reflectivity of the cell depends on the phase of the cell, and more specifically, the reflectivity of the cell is different when the phase of the cell is a crystal phase or an amorphous phase. Therefore, the information recorded on the cell may be reproduced by using the above described property.

To transform the cell from a crystal phase to an amorphous phase, a current pulse having a relatively short duration is applied to the cell at a high temperature of more than 700° C. On the contrary, to transform the cell from an amorphous phase to a crystal phase, a current pulse having a relatively long duration is applied to the cell at a temperature of more than 200° C. The application of current may be attained by applying a predetermined voltage between the lower electrode lines 120 and the upper electrode lines 140. For example, the lower electrode lines 120 are arranged in a y axis direction of the x-y plane, and the upper electrode lines 140 are arranged in an x axis direction of the x-y plane. When a critical voltage for inducing a phase change of any cell is regarded as V and the cell is located at a crossing region of any electrode lines of the lower electrode lines 120 and the upper electrode lines 140, a voltage of V/2 is applied to the corresponding electrode line of the lower electrode lines 120 and a voltage of −V/2 is applied to the corresponding electrode line of the upper electrode lines 140. Therefore, the critical voltage V is consequently applied to the cell located at the crossing region of the two electrode lines. The critical voltage V generates a current required for phase change at the cell, and heat due to the current is supplied to the cell. This heat induces the phase change in the cell. In this way, desired information may be recorded into all the cells of the information recording layer 130.

Next, a procedure for reproducing information recorded in the information storage medium in FIG. 1 will be described in the following.

With reference to FIG. 1, a light beam 150 is incident on a beam splitter 160, and the light is directed to the information storage medium by the beam splitter 1-60. Then, the incident light is focused on a predetermined cell of the information storage medium by an objective lens 170. The incident light is reflected on the predetermined cell of the information storage medium in accordance with the reflectivity of the cell. The reflected light passes through the objective lens 170 and the beam splitter 160 sequentially, and arrives at an optical detector cell 180. The optical detector cell 180 detects the reflectivity of the incident light and reproduces information recorded in the cell in accordance with the detected reflectivity information. The information storage medium of the present invention does not require a land-groove structure for tracking, differently from a conventional CD or DVD.

With reference to FIG. 2, an information storage medium of a second embodiment will be described in the following.

The information storage medium of the second embodiment is an active type medium and has a characteristic such that a transistor is provided in each cell and controls current supply to the corresponding cell.

As illustrated in FIG. 2, the information storage medium of the second embodiment comprises a plurality of transistors each having a P− region, an N region, and a P+ region, each being formed sequentially; a plurality of lower electrode lines 120 that are arranged in parallel with one another and are apart from one another at a constant interval; a plurality of upper electrode lines 140 that are arranged to cross the lower electrode lines, each upper electrode line being arranged in parallel with one another and apart from one another at a constant interval; and an information recording layer 130 that is formed between the lower electrode lines 120 and the upper electrode lines 140. In addition, a silicon oxide film 210 is coated on the entire surface of the resultant structure.

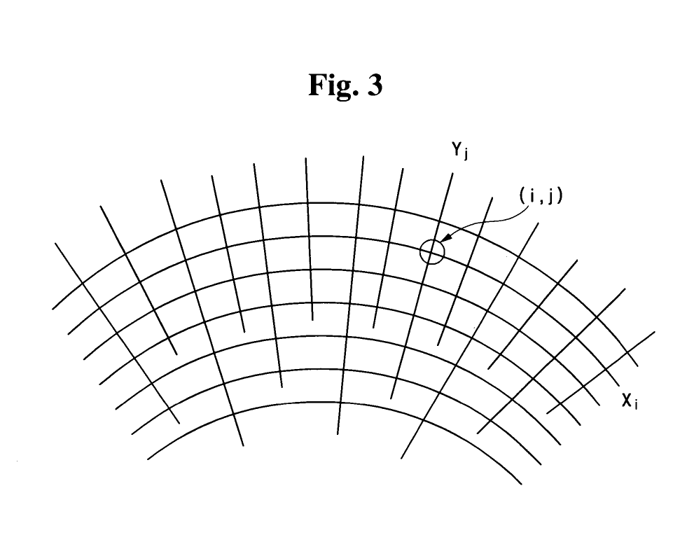

A region of the information recording layer 130 where any one electrode line of the lower electrode lines 120 crosses any one electrode line of the upper electrode lines 140 may be defined as a cell in this specification. The transistors are respectively provided at each cell in the information storage medium of this embodiment, and they actively control current supply to the corresponding cell. According to the information storage medium of the second embodiment, a critical voltage is applied to any one of the cells through a transistor corresponding to the cell, and thus leakage current at the cell may be minimized. This results in a reduction of power consumption. In the case of fabricating the information storage medium of the second embodiment, the electrode lines are fabricated on a silicon substrate together with the information recording layer through predetermined manufacturing processes. When the information storage medium is a card type, the electrode lines are formed to cross each other on the two-dimensional x-y plane, and thus fabrication and control of the electrode lines are simple. However, when the information storage medium is a disc type, fabrication of the electrode lines is very complex, as shown in FIG. 3. Such a complex structure is inevitable in order to increase recording capacity of the information storage medium by using the disc surface of the medium effectively.

A method for reproducing information recorded in the information storage medium according to the present invention is basically similar to the method used in a CD or DVD. An electro optical driving (EOD) method applicable to the present invention is required that can reproduce bit information recorded on a cell having a size smaller than that of a conventional optical disc. According to the present invention, a plurality of optical detectors are formed as one set. A light beam is reflected on any cell of the information storage medium at a predetermined reflectivity according to information recorded in the cell, then the optical detectors detect intensity distribution of the reflected light and reproduce information recorded in the cell through the intensity distribution.

This principle is very similar to an error-detecting method using a combination of optical detectors. According to the error-detecting method, information is reproduced by tracking a recording track of the convention CD or DVD. However, the EOD method is different from the error-detecting method in that it is possible to install the optical detector set in parallel with the recording track.

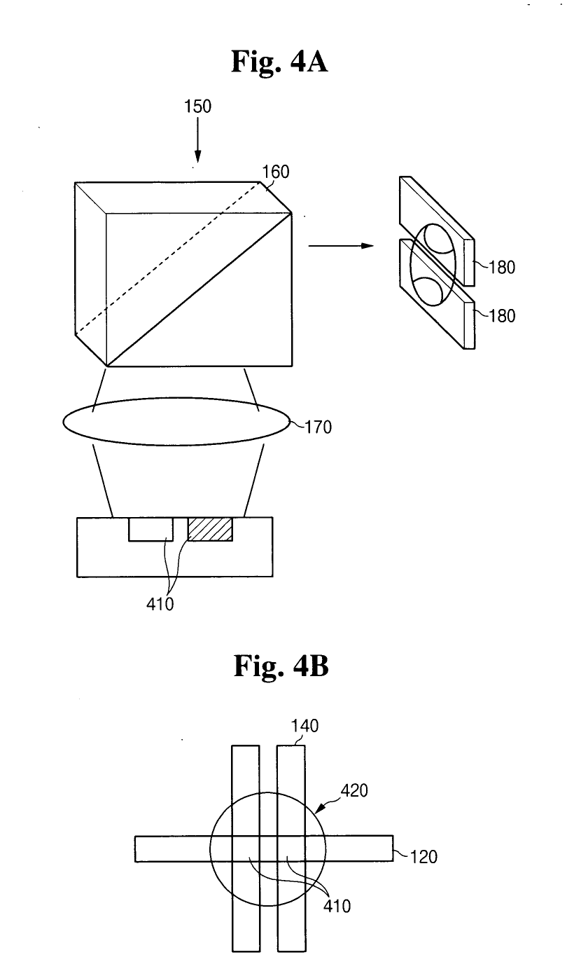

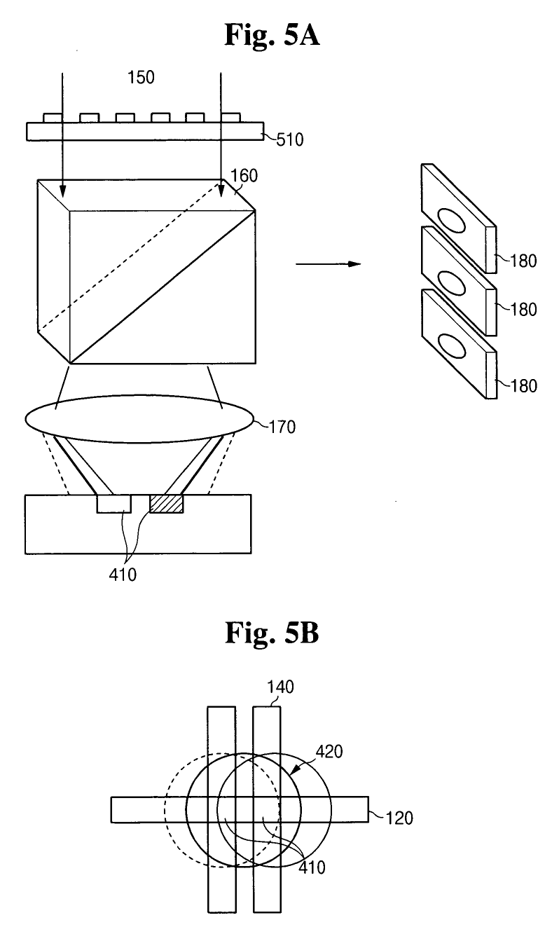

Next, an optical device for reproducing an information storage medium of the,present invention will be described with reference to FIG. 4 and FIG. 5.

A reproduction principle of an optical device for reproducing the information storage medium of the present invention is illustrated in FIG. 4a and FIG. 4b, and an optical device-further comprising a diffraction grating is illustrated in FIG. 5a and FIG. 5b.

With reference to FIG. 4b, two cells 410 having a size of less than a spot size of a light beam 420 are illustrated. An optical device simultaneously detects information recorded in the two cells 410 of the information storage medium.

As illustrated in FIG. 4a, the optical device comprises a beam splitter 160, an objective lens 170 and a pair of optical detectors 180. When a light beam 150 is incident on the beam splitter 160, the beam splitter 160 changes the direction of the light beam 150 toward the information storage medium. The objective lens 170 focuses the light beam outputted from the beam splitter 160 onto the corresponding cells 410 of the information storage medium. Information is previously recorded on the cells 410 by using the phase change property described above. In addition, the light reflected from the cells 410 has different reflectivity and direction in accordance with the phase of the cells 410.

The light reflected from the cells 410 passes through the objective lens 170 and the beam splitter 160 and arrives at the optical detector 180. The optical detector 180 detects a difference of reflectivity distribution at the cells 410 by measuring intensity of the reflected light, and reproduces information recorded in the information storage medium by the detected information. In FIG. 4b, two cells 410 having a size of less than a spot size of a light beam 420 are illustrated. The above-described reproduction principle of the optical device is similar to the reproduction principle of a conventional optical disc in that an optical detector is provided adjacent to, land-groove-type gratings of a conventional optical disc, and it performs tracking of the optical disc by measuring an intensity difference of light diffracted at the gratings.

The optical device illustrated in FIG. 5a has a characteristic such that a light beam passes through a diffraction grating 510 before being incident on the beam splitter 160. By using the diffraction grating 510, the 1st diffraction beam and the −1st diffraction beam pass through the beam splitter 160 and the objective lens 160, and are focused on the information storage medium. Thus, the focus of the diffraction beams is located to be away from the center of the cells 410, as illustrated in FIG. 5b.

The light beam is reflected from the cells 410 of the information storage medium and passes through the objective lens 170 and the beam splitter 160. Then, the reflected light beam arrives at the optical detector 180. The optical detector 180 detects light intensity of the reflected light beam and reproduces information recorded in the corresponding cells 410 by using the difference of the reflectivity distribution which may be obtained through the detected light intensity.

In the, above optical device, even though the optical detector is provided to be in parallel with the information recording medium as well as to be perpendicular to the circumference of the information recording medium, the optical detector 180 may detect the difference of the reflectivity distribution at each cell having a size of less than the size of the wavelength of the light beam.

As described above, the information storage medium of the present invention may overcome the restriction on recording density due to the diffraction limit of an optical beam. In the present invention, such an advantage may be obtained by forming a switching device such as a transistor at each cell of the information recording medium. In addition, information is recorded at a high speed on each cell having a size of less than the size of the wavelength of a light beam by using a phase-change property induced through the switching device. Then, an optical detector detects reflectivity distribution of a light beam reflected from each cell, and reproduces information recorded in each cell by the detected information. Moreover, the seeking time required for recording information on the information storage medium may be reduced by using the transistor to record information at each cell and the number of rewrites to the storage medium may be increased. Moreover, the present invention may obtain an information storage medium having a recording density of 300 Gb/in². Such a recording density is highly increased as compared with the 100 Gb/in² that may be obtained in the convention multi-level recording method.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An information storage medium, comprising:
a substrate;
a plurality of lower electrode lines that are arranged on the substrate to be in parallel with one another and apart from one another at a constant interval;
a plurality of upper electrode lines that are arranged to cross the lower electrode lines while being arranged in parallel with one another and apart from one another at a constant interval; and,
an information layer having cells that are arranged in a matrix and located at each crossing region of the lower electrode lines and the upper electrode lines.

2. The information storage medium according to claim 1, wherein the information recording layer is made of a phase-change.

3. The information storage medium according to claim 1, wherein the lower electrode lines and the upper electrode lines are made of a metal material.

4. The information storage medium according to claim 1, wherein each of the lower electrode lines and the upper electrode lines has a thickness of less than 50 nanometers.

5. The information storage medium according to claim 1, wherein the lower electrode lines and the upper electrode lines are formed as transparent electrodes.

6. The information storage medium according to claim 1, wherein a silicon oxide film is coated on the entire surface of the information storage medium, and a transistor is formed below each cell by forming a P− region, an N region, and a P+ region sequentially.

7. An optical device for reproducing information recorded in an information storage medium having cells of less than a spot size of a light beam, comprising:
a beam splitter for directing an incident light beam to the information storage medium while receiving the light beam reflected from the information storage medium and changing direction of the received light beam to be outputted;
an objective lens for focusing the light beam from the beam splitter on the cells of the information storage medium while transferring the light beam reflected from the information storage medium to the beam splitter; and,
an optical detector for receiving the light beam from the beam splitter and reproducing information recorded in the information storage medium by detecting a reflectivity difference at each cell through the received light beam.

8. The optical device according to claim 7, wherein the optical device further comprises a diffraction grating for extracting a 1st diffraction beam and a −1st diffraction beam from the light beam incident on the beam splitter.

9. The information storage medium defined by claim 2 wherein said phase change medium comprises a chalcogenide material.

10 The information storage medium defined by claim 3 wherein said metal material comprises at least one of gold, silver, copper, titanium, tungsten, aluminum, titanium nitride and aluminum nitride.

11. The information storage medium defined by claim 5 wherein said transparent electrodes comprise indium-tin-oxide.
